(19) United States
(12) Patent Application Publication
(10) Pub. No.: US 2015/0260333 A1
(43) Pub. Date: Sep. 17, 2015

(54) ROBOTIC STAND AND SYSTEMS AND METHODS FOR CONTROLLING THE STAND DURING VIDEOCONFERENCE

(71) Applicant: REVOLVE ROBOTICS, INC., San Francisco, CA (US)

(72) Inventors: Ilya Polyakov, San Francisco, CA (US); Marcus Rosenthal, San Francisco, CA (US)

(21) Appl. No.: 14/432,445

(22) PCT Filed: Sep. 30, 2013
(86) PCT No.: PCT/US13/62692

§ 371 Date: Mar. 30, 2015

Related U.S. Application Data
(60) Provisional application No. 61/708,440, filed on Oct. 1, 2012.
(60) Provisional application No. 61/734,308, filed on Dec. 6, 2012.

(51) Int. Cl. F16M 11/18; H04N 7/14; F16M 11/10; G06F 3/0484; F16M 11/04; G06F 3/0488; G06F 1/16

(52) U.S. Cl. CPC F16M 11/18; G06F 3/04883; H04N 7/142; G06F 1/1632; G06F 3/04847; G06F 1/1626; F16M 11/041; F16M 11/105

(57) ABSTRACT

A robotic stand and systems and methods for controlling the stand during a videoconference are provided. The robotic stand may support a computing device during a videoconference and may be remotely controllable. The robotic stand may include a base, a first member, a second member, and a remotely-controllable rotary actuator. The first member may be attached to the base and swivelable relative to the base about a pan axis. The second member may be attached to the first member and may be tiltable relative to the first member about a tilt axis. The rotary actuator may be associated with the first member and operative to swivel the first member about the pan axis. In response to receiving a signal containing a motion command, the robotic stand may autonomously move the computing device about at least one of the pan axis or the tilt axis.

### CROSS-REFERENCE TO RELATED APPLICATIONS

This application claims the benefit of U.S. provisional patent application No. 61/708,440, filed Oct. 1, 2012, and U.S. provisional patent application No. 61/734,308, filed Dec. 6, 2012, the entire disclosures of which are hereby incorporated by reference herein.

### TECHNICAL FIELD

The present disclosure relates generally to videoconferencing. More particularly, various examples of the present disclosure relate to a robotic stand and systems and methods for controlling the stand during a videoconference.

### BACKGROUND

Videoconferencing allows two or more locations to communicate simultaneously or substantially simultaneously via audio and video transmissions. Videoconferencing may connect individuals (such point-to-point calls between two units, also known as videophone calls) or groups (such as conference calls between multiple locations). In other words, videoconferencing includes calling or conferencing on a one-on-one, one-to-many, or many-to-many basis.

Each site participating in a videoconference typically has videoconferencing equipment capable of two-way audio and video transmissions. The videoconferencing equipment generally includes a data processing unit, an audio input and output, a video input and output, and a network connection for data transfer. Some or all of the components may be packaged into a single piece of equipment.

### SUMMARY

Examples of the disclosure may include a robotic stand for supporting a computing device at an elevated position during a teleconference. For example, the robotic stand may support the computing device above a support or work surface including a tabletop, a floor, or other suitable surfaces. The robotic stand may be operative to orient a computing device about at least one of a pan axis or a tilt axis during a videoconference. The robotic stand may include a base, a first member attached to the base, a second member attached to the first member, and a remotely-controllable rotary actuator associated with the first member. The first member may be swivelable relative to the base about a pan axis, and the rotary actuator may be operative to swivel the first member about the pan axis. The second member may be tiltable relative to the first member about a tilt axis, and the computing device may be attached to the second member.

The robotic stand may include a remotely-controllable rotary actuator associated with the second member and operative to tilt the second member about the tilt axis. The robotic stand may include multiple elongate arms each pivotally attached to the second member. The multiple elongate arms may be biased toward one another. The robotic stand may include a gripping member attached to a free end of each elongate arm of the multiple elongate arms. The robotic stand may include a gripping member attached directly to the second member. The robotic stand may include a counterbalance spring attached at a first end to the first member and at a second end to the second member. The counterbalance spring may be offset from the tilt axis. The robotic stand may include a microphone array attached to at least one of the base, the first member, or the second member.

Examples of the disclosure may include a method of orienting a local computing device during a videoconference established between the local computing device and one or more remote computing devices. The method may include supporting the local computing device at an elevated position, receiving a motion command signal from the local computing device, and in response to receiving the motion command signal, autonomously moving the local computing device about at least one of a pan axis or a tilt axis according to a positioning instruction received at the one or more remote computing devices. The motion command signal may be generated from the positioning instruction received at the one or more remote computing devices.

The motion command signal may include a pan motion command operative to pan the local computing device about the pan axis. The motion command signal may include a tilt motion command operative to tilt the local computing device about the tilt axis. The method may include moving the local computing device about the pan axis and the tilt axis. The method may include rotating the local computing device about the pan axis and tilting the local computing device about the tilt axis. The method may include gripping opposing edges of the local computing device with pivotable arms. The method may include biasing the pivotable arms toward one another. The method may include counterbalancing a weight of the local computing device about the tilt axis.

Examples of the disclosure may include automatically tracking an object during a videoconference with a computing device supported on a robotic stand. The method may include receiving sound waves with a directional microphone array, transmitting an electrical signal containing directional sound data to a processor, determining, by the processor, a location of a source of the directional sound data, and rotating the robotic stand about at least one of a pan axis or a tilt axis without user interaction to aim the computing device at the location of the source of the directional sound data.

Rotating the robotic stand about the at least one of a pan axis or a tilt axis may include actuating a rotary actuator associated with the at least one of a pan axis or a tilt axis. The method may include generating, by the processor, a motion command signal and transmitting the motion command signal to the rotary actuator to actuate the rotary actuator.

Examples of the disclosure may include a method of remotely controlling an orientation of a computing device supported on a robotic stand during a videoconference. The method may include receiving a video feed from the computing device, displaying the video feed on a screen, receiving a positioning instruction from a user to move the computing device about at least one of a pan axis or a tilt axis, and sending over a communications network a signal comprising the positioning instruction to the computing device.

The method may include displaying a user interface that allows a user to remotely control the orientation of the computing device. The displaying a user interface may include overlaying the video feed with a grid comprising a plurality of selectable cells. Each cell of the plurality of selectable cells may be associated with a pan and tilt position of the computing device. The receiving the positioning instruction from the user may include receiving an indication the user pressed an incremental move button. The receiving the positioning instruction from the user may include receiving an indication the user selected an area of the video feed for centering. The receiving the positioning instruction from the user may include receiving an indication the user selected an object of the video feed for automatic tracking. The receiving the indication may include receiving a user input identifying the object of the video feed displayed on the screen; in response to receiving the identification, displaying a graphical symbol on the screen illustrating a time period associated with initiation of the automatic tracking; continuing to receive the user input identifying the object for the time period; and in response to completion of the time period, triggering the automatic tracking of the identified object. The method may include receiving a storing instruction from a user to store a pan and tilt position; in response to receiving the storing instruction, storing the pan and tilt position; and in response to receiving the storing instruction, associating the pan and tilt position with a user interface element. The method may include storing a still image of the video feed and associating position data with the still image in response to a gesture performed by the user.

This summary of the disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of examples, it should be appreciated that individual aspects of any example can be claimed separately or in combination with aspects and features of that example or any other example.

This summary is neither intended nor should it be construed as being representative of the full extent and scope of the present disclosure. The present disclosure is set forth in various levels of detail in this application and no limitation as to the scope of the claimed subject matter is intended by either the inclusion or non-inclusion of elements, components, or the like in this summary.

### BRIEF DESCRIPTION OF THE DRAWINGS

The accompanying drawings, which are incorporated in and constitute a part of the specification, illustrate examples of the disclosure and, together with the general description given above and the detailed description given below, serve to explain the principles of these examples.

FIG. 1 is a schematic diagram of a videoconference network system in accordance with an embodiment of the disclosure.

FIG. 2A is a schematic diagram of a remote computing device in accordance with an embodiment of the disclosure.

FIG. 2B is a schematic diagram of a local computing device in accordance with an embodiment of the disclosure.

FIG. 3 is a schematic diagram of a graphical user interface for display on a remote computing device in accordance with an embodiment of the disclosure.

FIG. 4A is a schematic diagram of a graphical user interface for display on a remote computing device in accordance with an embodiment of the disclosure.

FIG. 4B is a schematic diagram of a graphical user interface for display on a remote computing device in accordance with an embodiment of the disclosure.

FIG. 4C is a schematic diagram of a graphical user interface for display on a remote computing device in accordance with an embodiment of the disclosure.

FIG. 4D is a schematic diagram of a graphical user interface for display on a remote computing device in accordance with an embodiment of the disclosure.

FIG. 5A is a schematic diagram of a graphical user interface for display on a remote computing device in accordance with an embodiment of the disclosure.

FIG. 5B is a schematic diagram of a graphical user interface for display on a remote computing device in accordance with an embodiment of the disclosure.

FIG. 5C is a schematic diagram of a graphical user interface for display on a remote computing device in accordance with an embodiment of the disclosure.

FIG. 5D is a schematic diagram of a graphical user interface for display on a remote computing device in accordance with an embodiment of the disclosure.

FIG. 6 is a schematic diagram of a robotic stand in accordance with an embodiment of the disclosure.

FIG. 7A is a side elevation view of a local computing device mounted onto a robotic stand in accordance with an embodiment of the disclosure.

FIG. 7B is a rear isometric view of a local computing device mounted onto a robotic stand in accordance with an embodiment of the disclosure.

FIG. 8 is a front elevation view of a robotic stand in accordance with an embodiment of the disclosure.

FIG. 9A is a side elevation view of a local computing device mounted onto a robotic stand in a tilted configuration in accordance with an embodiment of the disclosure.

FIG. 9B is a schematic diagram of a local computing device mounted onto a robotic stand in a tilted configuration in accordance with an embodiment of the disclosure.

FIG. 10A is a rear isometric view of a local computing device mounted onto a robotic stand in accordance with an embodiment of the disclosure.

FIG. 10B is a rear isometric view of a local computing device mounted onto a robotic stand in accordance with an embodiment of the disclosure.

FIG. 11 is a flowchart illustrating a set of operations for orienting a local computing device supported on a robotic stand in accordance with an embodiment of the disclosure.

FIG. 12 is a flowchart illustrating a set of operations for remotely controlling an orientation of a local computing device supported on a robotic stand in accordance with an embodiment of the disclosure.

It should be understood that the drawings are not necessarily to scale. In certain instances, details that are not necessary for an understanding of the disclosure or that render other details difficult to perceive may have been omitted. In the appended drawings, similar components and/or features may have the same reference label. It should be understood that the claimed subject matter is not necessarily limited to the particular examples or arrangements illustrated herein.

### DETAILED DESCRIPTION

The present disclosure describes examples of robotic stands for use in conducting a videoconference. The robotic stand, a local computing device, and a remote computing device may be in communication with one another during the videoconference. The local computing device may be mounted onto the robotic stand and may be electrically coupled to the stand (e.g. in electronic communication with the stand). A remote participant in the videoconference, or other entity, may control the orientation of the local computing device by interacting with the remote computing device and generating motion commands for the robotic stand. For example, the remote participant may generate pan and/or tilt commands using the remote computing device and transmit the commands to the local computing device, the robotic stand, or both. The robotic stand may receive the commands and rotate the local computing device about a pan axis, a tilt axis, or both in accordance with the commands received from the remote participant. As such, a user of a remote computing device may control the orientation of a local computing device real-time during a live videoconference.

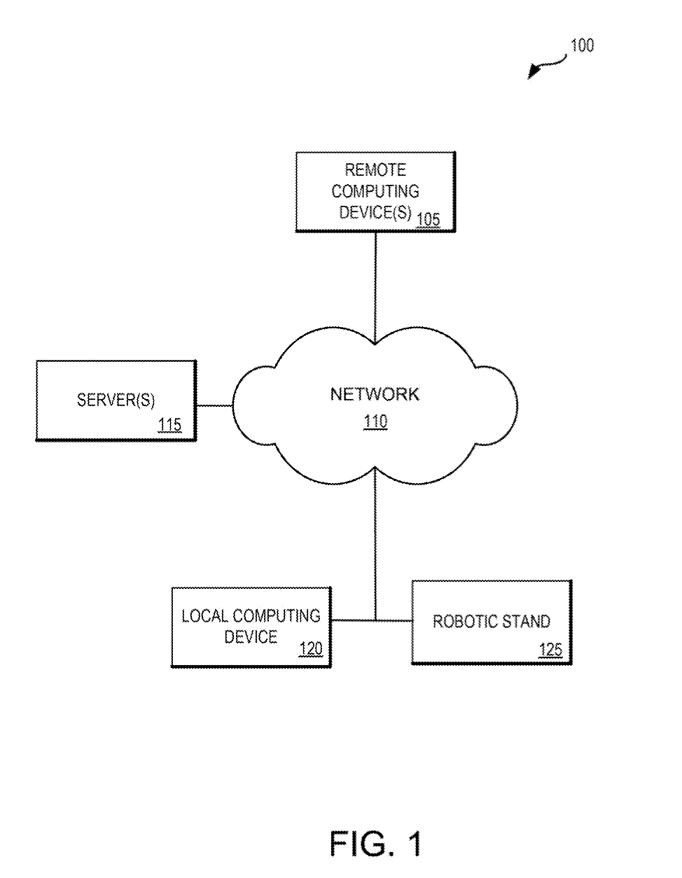

FIG. 1 is a schematic diagram of a videoconference system 100 in accordance with an embodiment of the disclosure. The videoconference system 100 may include one or more remote computing devices 105, a communications network 110, one or more servers 115, a local computing device 120, and a robotic stand 125. Although not depicted, the videoconference system 100 may include network equipment (such as modems, routers, and switches) to facilitate communication through the network 110.

The one or more remote computing devices 105 may include, but are not limited to, a desktop computer, a laptop computer, a tablet, a smart phone, or any other computing device capable of transmitting and receiving videoconference data. Each of the remote computing devices 105 may be configured to communicate over the network 110 with any number of devices, including the one or more servers 115, the local computing device 120, and the robotic stand 125. The network 110 may comprise one or more networks, such as campus area networks (CANs), local area networks (LANs), metropolitan area networks (MANs), personal area networks (PANs), wide area networks (WANs), cellular networks, and/or the Internet. Communications provided to, from, and within the network 110 may wired and/or wireless, and further may be provided by any networking devices known in the art, now or in the future. Devices communicating over the network 110 may communicate by way of various communication protocols, including TCP/IP, UDP, RS-232, and IEEE 802.11.

The one or more servers 115 may include any type of processing resources dedicated to performing certain functions discussed herein. For example, the one or more servers 115 may include an application or destination server configured to provide the remote and/or local computing devices 105, 120 with access to one or more applications stored on the server. In some embodiments, for example, an application server may be configured to stream, transmit, or otherwise provide application data to the remote and/or local computing devices 105, 120 such that the devices 105, 120 and an application server may establish a session, for example a video client session, in which a user may utilize on the remote or local computing devices 105, 120 a particular application hosted on the application server. As another example, the one or more servers 115 may include an Internet Content Adaptation Protocol (ICAP) server, which may reduce consumption of resources of another server, such as an application server, by separately performing operations such as content filtering, compression, and virus and malware scanning. In particular, the ICAP server may perform operations on content exchanged between the remote and/or local computing devices 105, 120 and an application server. As a further example, the one or more servers 115 may include a web server having hardware and software that delivers web pages and related content to clients (e.g., the remote and local computing devices 105, 120) via any type of markup language (e.g., HyperText Markup Language (HTML) or eXtensible Markup Language (XML)) or other suitable language or protocol.

The local computing device 120 may include a laptop computer, a tablet, a smart phone, or any other mobile or portable computing device that is capable of transmitting and receiving videoconference data. The local computing device 120 may be a mobile computing device including a display or screen that is capable of displaying video data. The local computing device 120 may be mounted onto the robotic stand 125 to permit a user of one of the remote computing devices 105 to remotely orient the local computing device 120 during a videoconference. For example, a user of one of the remote computing devices 105 may remotely pan and/or tilt the local computing device 120 during a videoconference, for example by controlling the robotic stand 125. The local computing device 120 may be electrically coupled to the robotic stand 125 by a wired connection, a wireless connection, or both. For example, the local computing device 120 and the robotic stand 125 may communicate wirelessly using Bluetooth.

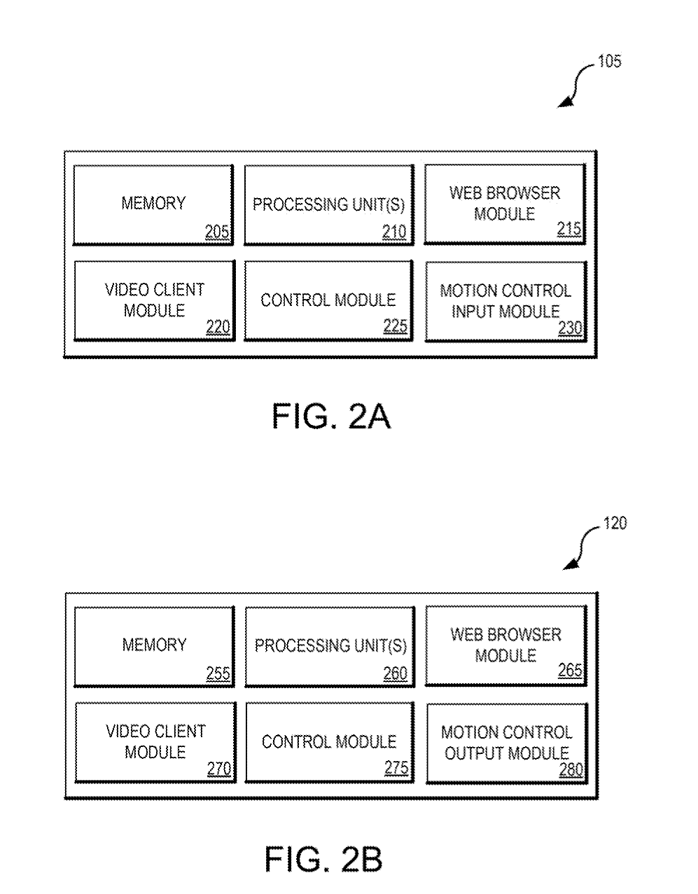

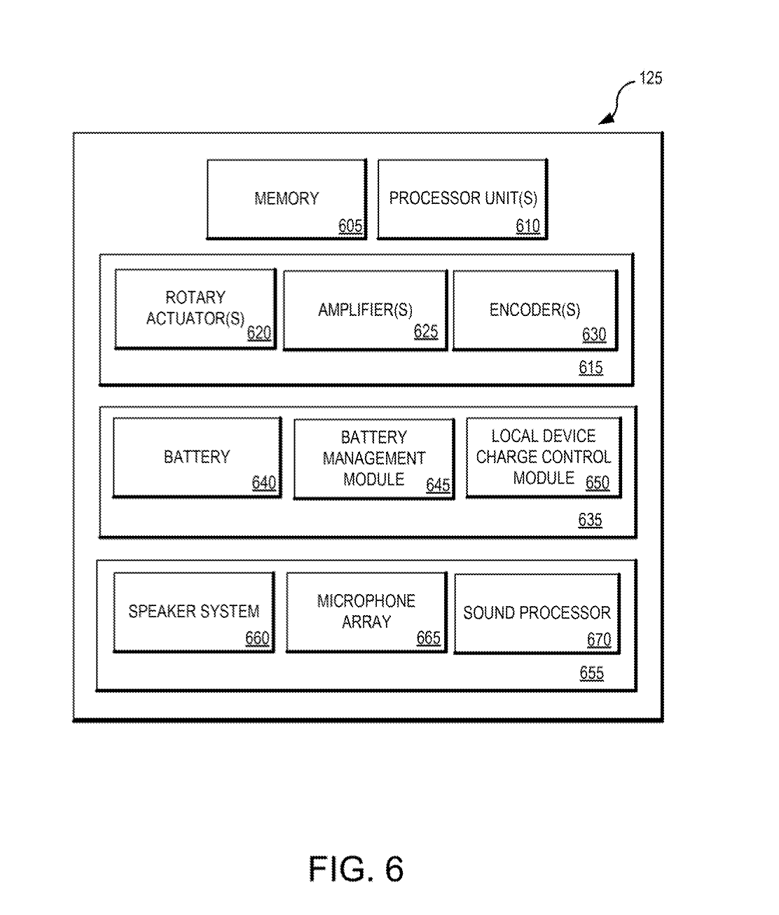

FIG. 2A is a schematic diagram of an example remote computing device. FIG. 2B is a schematic diagram of an example local computing device. FIG. 6 is a schematic diagram of an example robotic stand. As shown in FIGS. 2A, 2B, and 6, the remote computing device(s) 105, the local computing device 120, and the robotic stand 125 may each include a memory 205, 255, 605 in communication with one or more processing units 210, 260, 610, respectively. The memory 205, 255, 605 may include any form of computer readable memory, transitory or non-transitory, including but not limited to externally or internally attached hard-disk drives, solid-state storage (such as NAND flash or NOR flash media), tiered storage solutions, storage area networks, network attached storage, and/or optical storage. The memory 205, 255, 605 may store executable instructions for execution by the one of more processing units 210, 260, 610, which may include one or more Integrated Circuits (ICs), a Digital Signal Processor (DSP), an Application Specific IC (ASIC), a controller, a Programmable Logic Device (PLD), a logic circuit, or the like. The one or more processing units 210, 260, 610 may include a general-purpose programmable processor controller for executing application programming or instructions stored in memory 205, 255, 605. The one or more processing units 210, 260, 610 may include multiple processor cores and/or implement multiple virtual processors. The one or more processing units 210, 260, 610 may include a plurality of physically different processors. The memory 205, 255, 605 may be encoded with executable instructions for causing the processing units 210, 260, 610, respectively to perform acts described herein. In this manner, the remote computing device, local computing device, and/or robotic stand may be programmed to perform functions described herein.

It is to be understood that the arrangement of computing components described herein is quite flexible. While a single memory or processing unit may be shown in a particular view or described with respect to a particular system, it is to be understood that multiple memories and/or processing units may be employed to perform the described functions.

With reference to FIGS. 2A and 2B, the remote computing device(s) 105 and the local computing device 120 may include a web browser module 215, 265, respectively. The web browser modules 215, 265 may include executable instructions encoded in memory 205, 255 that may operate in conjunction with one or more processing units 210, 260 to provide functionality allowing execution of a web browser on the computing devices 105, 120, respectively. The web browser module 215, 265 may be configured to execute code of a web page and/or application. The web browser module 215,265 may comprise any web browser application known in the art, now or in the future, and may be executed in any operating environment or system. Example web browser applications include Internet Explorer®, Mozilla Firefox, Safari®, Google Chrome®, or the like that enables the computing devices 105, 120 to format one or more requests and send the requests to the one or more servers 115.

With continued reference to FIGS. 2A and 2B, the remote computing device(s) 105 and the local computing device 120 may include a video client module 220, 270, respectively. Each video client module 220, 270 may be a software application, which may be stored in the memory 205, 255 and executed by the one or more processing units 210, 260 of the computing devices 105, 120, respectively. The video client modules 220, 270 may transmit video data, audio data, or both through an established session between the one or more remote computing devices 105 and the local computing device 120, respectively. The session may be established, for example, by way of the network 110, the server(s) 115, the web browser modules 215, 265, or any combination thereof. In one implementation, the session is established between the computing devices 105, 120 via the Internet.

With further reference to FIGS. 2A and 2B, the remote computing device(s) 105 and the local computing device 120 may include a control module 225, 275, respectively. Each control module 225, 275 may be a software application, which may be stored in the memory 205, 255 and executed by the one or more processing units 210, 260 of the computing devices 105, 120, respectively. Each control module 225, 275 may transmit and/or receive motion control data through an established session between the one or more remote computing devices 105 and the local computing device 120, respectively. The motion control data may contain motion commands for the robotic stand 125.

In some implementations, the video client modules 220, 270 and the control modules 225, 275 are standalone software applications existing on the computing devices 105, 120, respectively, and running in parallel with one another. In these implementations, the video client modules 220, 270 may send video and audio data through a first session established between the video client modules 220, 270. The control modules 225, 275 may run in parallel with the video client modules 220, 270, respectively, and send motion control data through a second session established between the control modules 225, 275. The first and second sessions may be established, for example, by way of the network 110, the server(s) 115, the web browser modules 215, 265, or any combination thereof. In one implementation, the first and second sessions are established between the respective modules via the Internet.

In some implementations, the video client module 220, 270 and the control module 225, 275 are combined together into a single software application existing on the computing devices 105, 120, respectively. In these implementations, the video client modules 220, 270 and the control modules 225, 275 may send video data, audio data, and/or motion control data through a single session established between the computing devices 105, 120. The single session may be established, for example, by way of the network 110, the server(s) 115, the web browser modules 215, 265, or any combination thereof. In one implementation, the single session is established between the computing devices 105, 120 via the Internet.

With specific reference to FIG. 2A, the one or more remote computing devices 105 may include a motion control input module 230. In some implementations, the motion control input module 230 may be combined together with the video client module 220, the control module 225, or both into a single software application. In some implementations, the motion control input module 230 may be a standalone software application existing on the one or more remote computing devices 105. The motion control input module 230 may permit a user of a remote computing device 105 to control the movement of the local computing device 120. For example, the motion control input module 230 may provide various graphical user interfaces for display on a screen of the remote computing device 105. A user may interact with the graphical user interface displayed on the remote computing device 105 to generate motion control data, which may be transmitted to the local computing device 120 via a session between the computing devices 105, 120. The motion control data may contain motion commands generated from the user's input into the motion control input module 230 and may be used to remotely control the orientation of the local computing device 120.

With specific reference to FIG. 2B, the local computing device 120 may include a motion control output module 280. In some implementations, the motion control output module 280 may be combined together with the video client module 270, the control module 275, or both into a single software application. In some implementations, the motion control output module 280 may be a standalone software application existing on the local computing device 120. The motion control output module 280 may receive motion control data from the video client module 220, the control module 225, the user interface module 230, the video client module 270, the control module 275, or any combination thereof. The motion control output module 280 may decode motion commands from the motion control data. The motion control output module 280 may transmit the motion control data including motion commands to the robotic stand 125 via a wired and/or wireless connection. For example, the motion control output module 280 may transmit motion control data including motion commands to the stand 125 via a physical interface, such as a data port, between the local computing device 120 and the stand 125 or wirelessly over the network 110 with any communication protocol, including TCP/IP, UDP, RS-232, and IEEE 802.11. In one implementation, the motion control output module 280 transmits motion control data including motion commands to the stand 125 wirelessly via the Bluetooth communications protocol.

Although not depicted in FIGS. 2A and 2B, the one or more remote computing devices 105 and the local computing device 120 may include any number of input and/or output devices including but not limited to displays, touch screens, keyboards, mice, communication interfaces, and other suitable input and/or output devices.

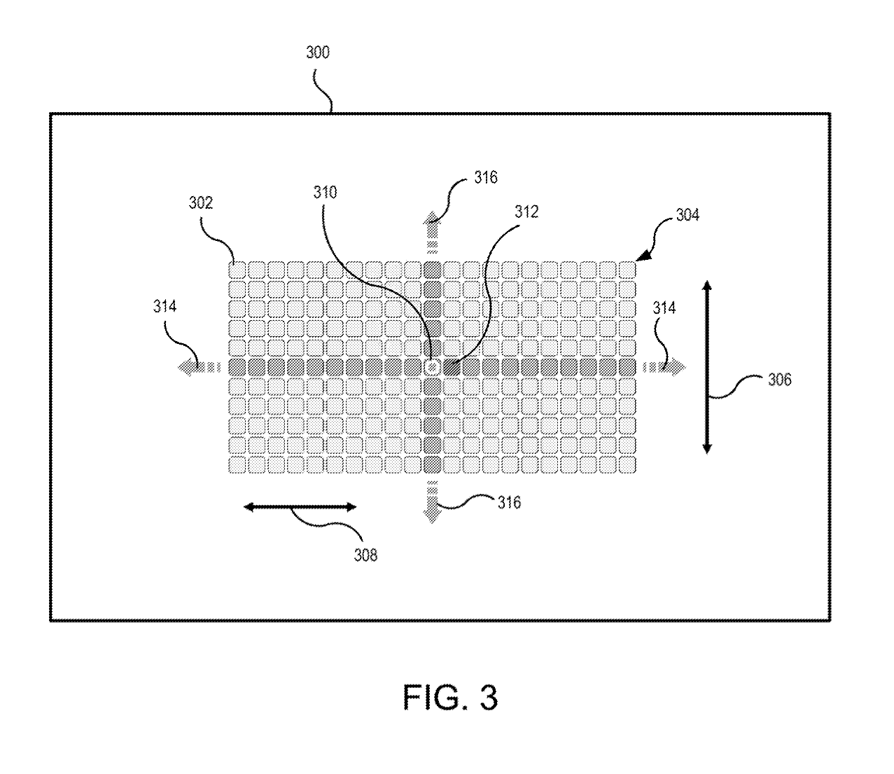

Remote control of the robotic stand 125 may be accomplished through numerous types of user interfaces. FIGS. 3-5D depict several example graphical user interfaces that may be displayed on a screen of the remote computing device 105. FIG. 3 is a schematic diagram of an example grid motion control user interface 300, which may be visibly or invisibly overlaid onto a video feed displayed on a screen of the remote computing device 105. In some examples, the grid motion control user interface 200 may be displayed on a screen of the remote computing device 105 without being overlaid on any other particular displayed information. The user interface 300 may include a plurality of cells 302 arranged in a coordinate system or grid 304 having multiple rows and columns of cells 302. The coordinate system 304 may represent a range of motion of the robotic stand 125. The coordinate system 304 may include a vertical axis 306 corresponding to a tilt axis of the robotic stand 125 and a horizontal axis 308 corresponding to a pan axis of the stand 125. A centrally-located cell 310 may be distinctly marked to denote the center of the coordinate space 304.

Each cell 302 may represent a discrete position within the coordinate system 304. The current tilt and pan position of the robotic stand 125 may be denoted by visually distinguishing a cell 312 from the rest of the cells, such as highlighting the cell 312 and/or distinctly coloring the cell 312. A remote user may incrementally move the robotic stand 125 by pressing incremental move buttons 314, 316 situated along side portions of the coordinate system 304. The incremental move buttons 314, 316 may be represented by arrows pointing in the desired movement direction. A remote user may click on an incremental pan button 314 to incrementally pan the robotic stand 125 in the direction of the clicked arrow. Similarly, a remote user may click on an incremental tilt button 316 to incrementally tilt the robotic stand 125 in the direction of the clicked arrow. Each click of the incremental move buttons 314, 316 may move the current cell 312 by one cell in the direction of the clicked arrow. Additionally or alternatively, each cell 302 may be a button and may be selectable by a user of the remote computing device 105. Upon a user clicking or tapping (e.g. touching) one of the cells 302, the remote computing device 105 may transmit a signal containing motion command data to the local computing device 120, the robotic stand 125, or both. The motion command data may include a motion command to pan and/or tilt the local computing device 120 to an orientation associated with the selected cell. The robotic stand 125 may receive the motion command and move the local computing device 120 to the desired pan and tilt position. A user of the remote computing device 105 may orient the local computing device 105 into any orientation within a motion range of the robotic stand 125 by selecting any cell 302 within the coordinate space 304. In some examples, the cells 302 may not be displayed. However, a touch or click at a location on the screen may be translated into pan and/or tilt commands in accordance with the position of the click or tap on the screen.

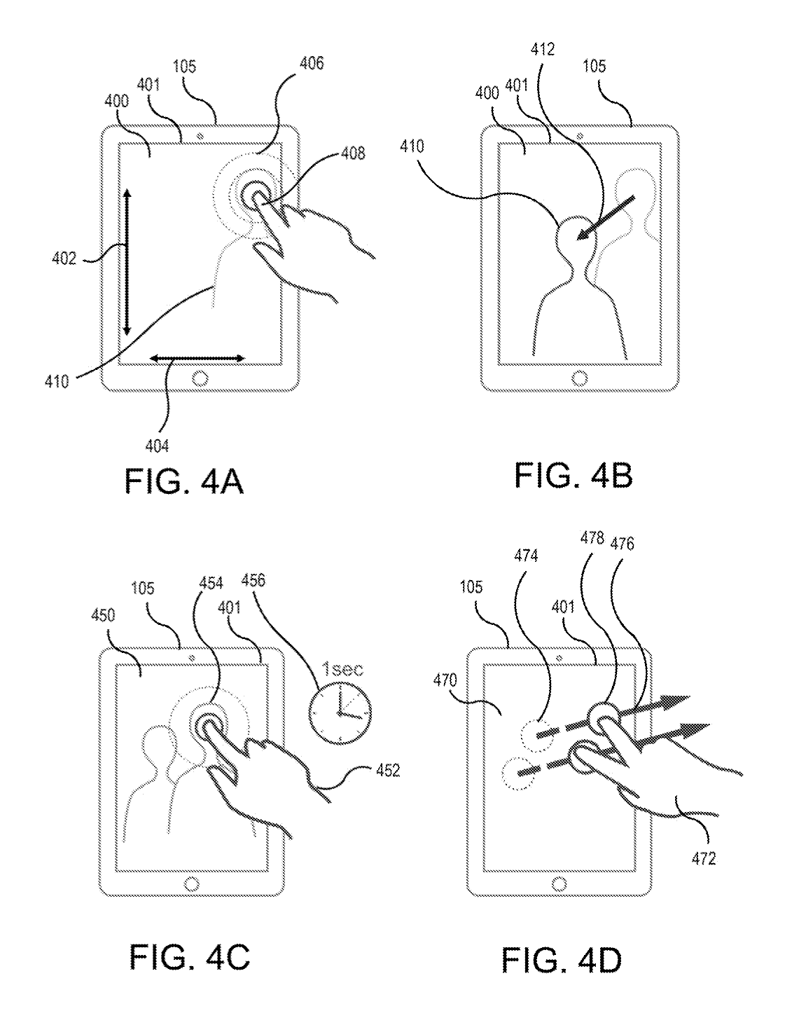

FIGS. 4A and 4B are schematic diagrams of an example tap-to-center motion control user interface 400 displayed on an example remote computing device 105. The user interface 400 may display a live video feed on the screen 401 of the remote computing device 105. A user may click or tap on any part of the screen 401 to center the selected area of interest 406 on the screen 401. By clicking or tapping on an off-centered image displayed on the screen 401 of the remote computing device 105, the remote user may initiate a motion command signal that results in movement of the robotic stand 125 such that the clicked or tapped image is centered on the screen 401. In some implementations, the user interface 400 may overlay the video feed with a visible or invisible grid representing coordinate space axes 402, 404. A user of the remote computing device 105 may click or tap an area of interest 406 with a finger 408, for example, anywhere within the coordinate space to initiate a move command proportional to the distance between the clicked or tapped location 406 and the center of the coordinate space. The remote computing device 105 may communicate the move command to the local computing device 120, the robotic stand 125, or both, resulting in motion of the stand 125 to center the selected area 406 on the screen 401. FIG. 4B illustrates the centering functionality of the user interface 400 with an arrow 412 that represents a centering vector originating at the previous location of the image 410, as shown in FIG. 4A, and terminating at the centered location of the image 410, as shown in FIG. 4B.

FIG. 4C is a schematic diagram of an example object tracking user interface 450 displayed on an example remote computing device 105. To initiate automatic object tracking by the robotic stand 125, a user 452 of the remote computing device 105 may select a part of an image 454 displayed on the device 105 during a live video feed that the user 452 wants the stand 125 to track. The selection may be accomplished by a user 452 tapping and holding their finger on the desired object for a period of time 456. The time elapsed or remaining until the tracking command is initiated may be visually shown on the screen of the device 105 with a graphical element or symbol, such as the depicted clock. Once object tracking is triggered, the remote computing device 105 may transmit the data related to the selected object 454 to the local computing device 120, which is mounted onto the robotic stand 125. The local computing device 120 may convert the movement of the pixels representing the object 454 into motion command data for the robotic stand 125. The motion command data may include pan motion commands, tilt motion commands, or both. A single fast tap anywhere on the screen of the remote computing device 105 may stop tracking of the selected object 454 and ready the system to track another object.

FIG. 4D is a schematic diagram of an example gesture motion control user interface 470 displayed on an example remote computing device 105. The user interface 470 may permit a user 472 of the remote computing device 105 to perform a gesture on a touch screen 401 of the device 105 to move the position of the robotic stand 125, and thus the video feed associated with the local computing device 110, directly. The magnitude and direction of movement 476 of the gesture may be calculated between a starting gesture position 474 and an ending gesture position 478. The movement data 476 may be converted to motion commands for the pan and/or tilt axes of the robotic stand 125. In some examples, the absolute position of the gesture on the screen may not be used for conversion to motion commands for the pan and/or tilt axes of the robotic stand 125. Instead, in some examples, the pattern defined by the gesture may be converted to motion commands. For example, the vector shown in FIG. 4D may be translated into a motion command reflecting an amount of pan and tilt from the current position represented by the vector. Anywhere on the screen where the gesture is performed may result in conversion of the vector to pan and tilt commands for the robotic stand from the current position.

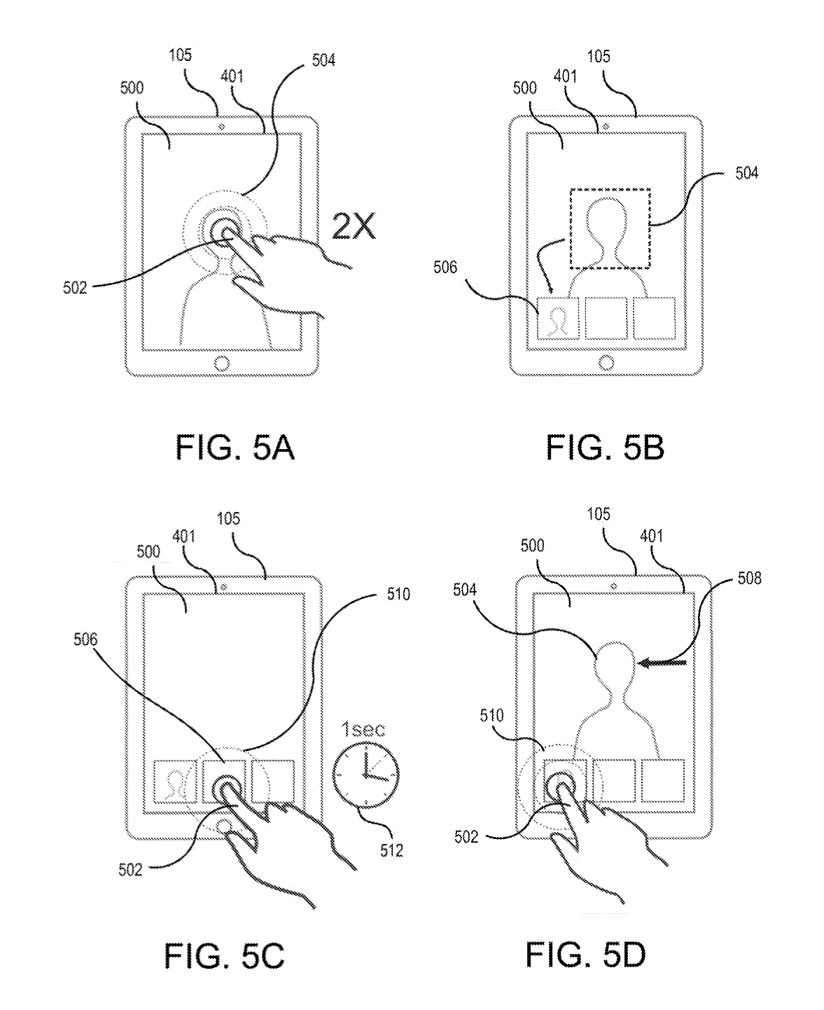

FIGS. 5A-5D are schematic diagrams of an example user interface 500 providing a stored location functionality. The user interface 500 provides a user of the remote computing device 105 the capability to revisit a location within a motion coordinate system of the pan and tilt axes of a robotic stand 125. To save a location, a remote user may perform a gesture, such as a fast double tap with a user's finger 502, to select an area 504 of the video feed on the screen 401 of the remote computing device 105. The selected area 504 of the video feed may correspond to a physical pan and tilt position of the robotic stand 125. The user interface 500 may capture a still image of the area 504 of the video feed and display a thumbnail 506 of the selected area 504 along a bottom portion of the screen 401 (see FIG. 5B). The corresponding pan and tilt position data of the robotic stand 125 may be stored and associated with the thumbnail 506. To move the robotic stand 125 back to the stored position, a user may tap or click on the thumbnail image 506 to initiate a move 508 from the current pan and tilt position of the stand 125 to the stored pan and tilt position associated with the thumbnail image 506 (see FIGS. 5C-5D). Multiple images and associated positions may be stored along a bottom portion of the screen of the remote computing device 105. To remove a thumbnail image and associated position from memory, a user may press and hold 510 a finger 502 on the thumbnail image 5016 to be deleted for a set period of time 512. The image 506 may be deleted once the set period of time 512 is elapsed. The time elapsed while pressing and holding 510 a finger 502 on a thumbnail image 506 may be represented with a dynamic element or symbol, such as the depicted clock. In some implementations, the stored position data may be associated with a user interface element other than the thumbnail image 506. For example, the user interface 500 may include the stored positions listed as buttons or other user interface elements.

The provided user interface examples may be implemented using any computing system, such as but not limited to a desktop computer, a laptop computer, a tablet computer, a smart phone, or other computing systems. Generally, a computing system 105 for use in implementing example user interfaces described herein may include one or more processing unit(s) 210, and may include one or more computer readable mediums (which may be transitory or non-transitory and may be implemented, for example, using any type of memory or electronic storage 205 accessible to the computing system 105) encoded with executable instructions that, when executed by one or more of the processing unit(s) 210, may cause the computing system 105 to implement the user interfaces described herein. In some examples, therefore, a computing system 105 may be programmed to provide the example user interfaces described herein, including displaying the described images, receiving described inputs, and providing described outputs to a local computing device 120, a motorized stand 125, or both.

With reference to FIG. 6, the robotic stand 125, which may be referred to as a motorized or remotely-controllable stand, may include a memory 605, one or more processor units 610, a rotary actuator module 615, a power module 635, a sound module 655, or any combination thereof. The memory 605 may be in communication with the one or more processor units 610. The one or more processor units 610 may receive motion control data including motion commands from the local computing device 120 via a wired or wireless data connection. The motion control data may be stored in memory 605. The one or more processor units 610 may process the motion control data and transmit motion commands to a rotary actuator module 615. In some implementations, the one or more processor units 610 include a multipoint control unit (MCU).

With continued reference to FIG. 6, the rotary actuator module 615 may provide control of an angular position, velocity, and/or acceleration of the local computing device 120. The rotary actuator module 615 may receive a signal containing motion commands from the one or more processor units 610. The motion commands may be associated with one or more rotational axes of the robotic stand 125.

With further reference to FIG. 6, the rotary actuator module 615 may include one or more rotary actuators 620, one or more amplifiers 625, one or more encoders 630, or any combination thereof. The rotary actuator(s) 620 may receive a motion command signal from the processor unit(s) 610 and produce a rotary motion or torque in response to receiving the motion command signal. The amplifier(s) 625 may magnify the motion command signal received from the processor unit(s) 610 and transmit the amplified signal to the rotary actuator(s) 620. For implementations using multiple rotary actuators 620, a separate amplifier 625 may be associated with each rotary actuator 620. The encoder(s) 630 may measure the position, speed, and/or acceleration of the rotary actuator(s) 620 and provide the measured data to the processor unit(s) 610. The processor unit(s) 610 may compare the measured position, speed, and/or acceleration data to the commanded position, speed, and/or acceleration. If a discrepancy exists between the measured data and the commanded data, the processor unit(s) 610 may generate and transmit a motion command signal to the rotary actuator(s) 620, causing the rotary actuator(s) 620 to produce a rotary motion or torque in the appropriate direction. Once the measured data is the same as the commanded data, the processor unit(s) 610 may cease generating a motion command signal and the rotary actuator(s) 620 may stop producing a rotary motion or torque.

The rotary actuator module 615 may include a servomotor or a stepper motor, for example. In some implementations, the rotary actuator module 615 includes multiple servomotors associated with different axes. The rotary actuator module 615 may include a first servomotor associated with a first axis and a second servomotor associated with a second axis that is angled relative to the first axis. The first and second axes may be perpendicular or substantially perpendicular to one another. The first axis may be a pan axis, and the second axis may be a tilt axis. Upon receiving a motion command signal from the processor unit(s) 610, the first servomotor may rotate the local computing device 120 about the first axis. Likewise, upon receiving a motion command signal from the processor unit(s) 610, the second servomotor may rotate the local computing device 120 about the second axis. In some implementations, the rotary actuator module 615 may include a third servomotor associated with a third axis, which may be perpendicular or substantially perpendicular to the first and second axes. The third axis may be a roll axis. Upon receiving a motion command signal from the processor unit(s) 610, the third servomotor may rotate the local computing device 120 about the third axis. In some implementations, a user of the remote computing device 105 may control a fourth axis of the local computing device 120. For example, a user of the remote computing device 105 may remotely control a zoom functionality of the local computing device 120 real-time during a videoconference. The remote zoom functionality may be associated with the control modules 225, 275 of the remote and local computers 105, 120, for example.

Still referring to FIG. 6, the power module 635 may provide power to the robotic stand 125, the local computing device 120, or both. The power module 635 may include a power source, such as a battery 640, line power, or both. The battery 640 may be electrically coupled to the robotic stand 125, the local computing device 120, or both. A battery management module 645 may monitor the charge of the battery 640 and report the state of the battery 640 to the processor unit(s) 610. A local device charge control module 650 may be electrically coupled between the battery management module 645 and the local computing device 120. The local device charge control module 650 may monitor the charge of the local computing device 120 and report the state of the local computing device 120 to the battery management module 645. The battery management module 645 may control the charge of the battery 640 based on the power demands of the stand 125, the local computing device 120, or both. For example, the battery management module 645 may restrict charging of the local computing device 120 when the charge of the battery 640 is below a threshold charge level, the charge rate of the battery 640 is below a threshold charge rate level, or both.

With continued reference to FIG. 6, the sound module 655 may include a speaker system 660), a microphone array 665, a sound processor 670, or any combination thereof. The speaker system 660 may include one or more speakers that convert sound data received from a remote computing device 105 into sound waves that are decipherable by videoconference participant(s) at the local computing device 120. The speaker system 660 may form part of an audio system of the videoconference system. The speaker system 660 may be integral to or connected to the robotic stand 125.

The microphone array 665 may include one or more microphones that receive sound waves from the environment associated with the local computing device 120 and convert the sound waves into an electrical signal for transmission to the local computing device 120, the remote computing device 105, or both during a videoconference. The microphone array 665 may include three or more microphones spatially separated from one another for triangulation purposes. The microphone array 665 may be directional such that the electrical signal containing the local sound data includes the direction of the sound waves received at each microphone. The microphone array 665 may transmit the directional sound data in the form of an electrical signal to the sound processor 670, which may use the directional sound data to determine the location of the sound source. For example, the sound processor 670 may use triangulation methods to determine the source location. The sound processor 670 may transmit the sound data to the processor unit(s) 610, which may use the source data to generate motion commands for the rotary actuator(s) 620. The sound processor 670 may transmit the motion control commands to the rotary actuator module 615, which may produce rotary motion or torque based on the commands. As such, the robotic stand 125 may automatically track the sound originating around the local computing device 120 and may aim the local computing device 120 at the sound source without user interaction. The sound processor 670 may transmit the directional sound data to the local computing device 120, which in turn may transmit the data to the remote computing device(s) 105 for use in connection with a graphical user interface.

As explained above, various modules of the remote computing device(s) 105, the local computing device 120, and the robotic stand 125 may communicate with other modules by way of a wired or wireless connection. For example, various modules may be coupled to one another by a serial or parallel data connection. In some implementations, various modules are coupled to one another by way of a serial bus connection.

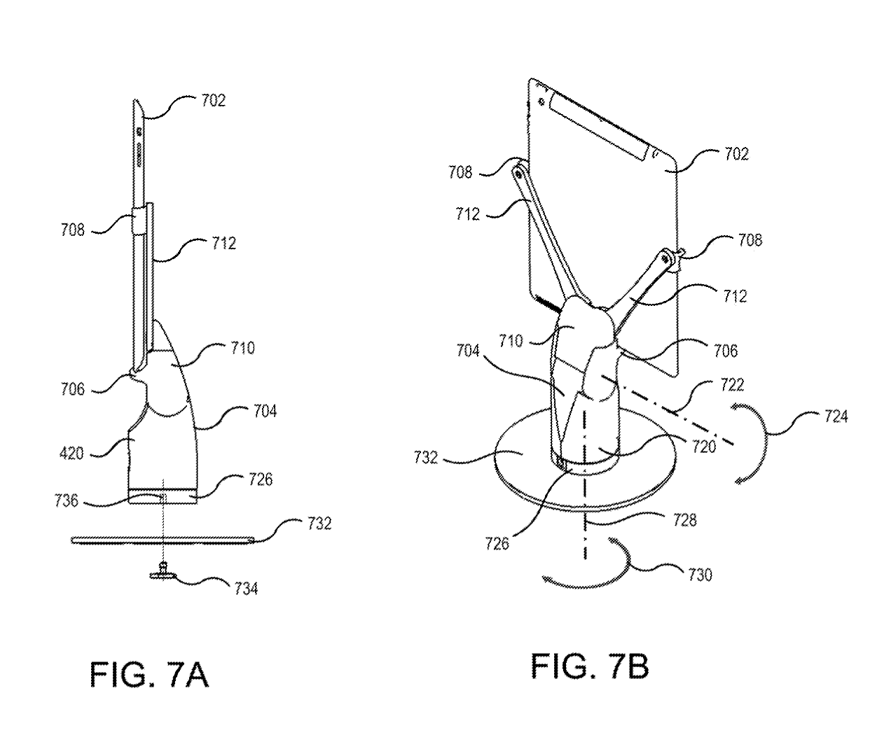

With reference to FIGS. 7A and 7B, an example local computing device 702 is mounted onto an example robotic stand 704. The local computing device 702 may be electrically coupled to the stand 704 via a wired and/or wireless connection. The local computing device 702 is depicted as a tablet computer, but other mobile computing devices may be supported by the stand 704.

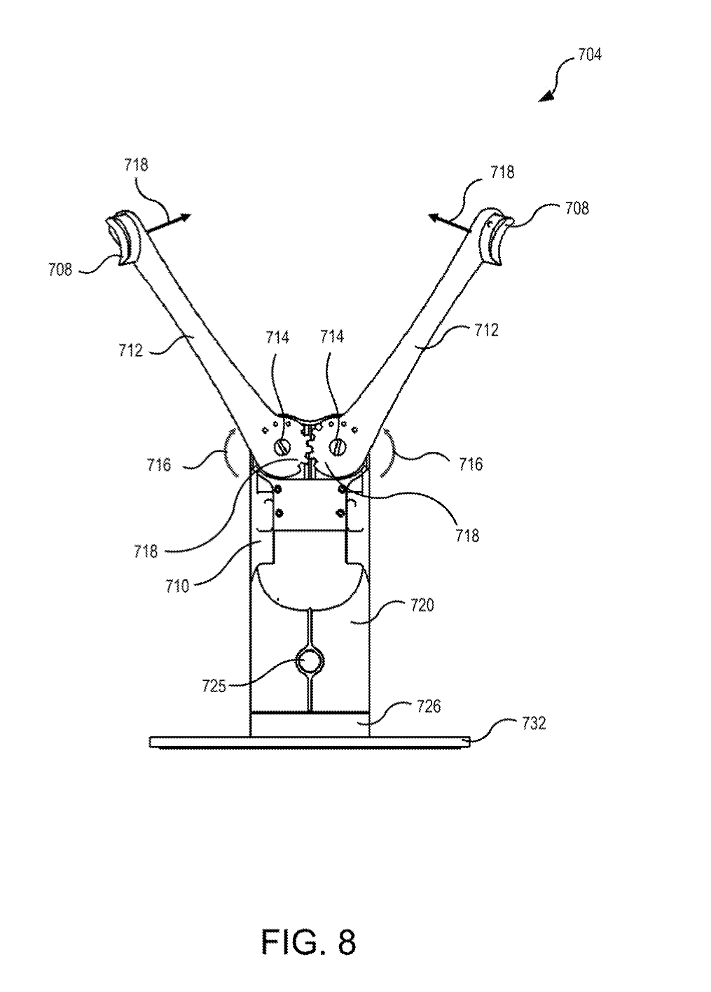

The local computing device 702 may be securely held by the robotic stand 704 such that the stand 704 may move the local computing device 702 about various axes without the local computing device 702 slipping relative to the stand 704. The stand 704 may include a vertical grip 706 that retains a lower edge of the local computing device 702 (see FIG. 7A). The stand 704 may include horizontal grips 708 that retain opposing side edges of the local computing device 702 (see FIGS. 7A and 7B). The vertical and horizontal grips 706, 708 may be attached to an articulable arm or tiltable member 710. The vertical grip 706 may be non-movable relative to the tiltable member 710, whereas the horizontal grips 708 may be movable relative to the tiltable member 710. As shown in FIGS. 7B and 8, the horizontal grips 708 may be coupled to the tiltable member 710 by elongate arms 712. The horizontal grips 708 may be rigidly or rotationally attached to free ends of the arms 712. The other ends of the arms 712 may be pivotally attached to the tiltable member 710 about pivot points 714 (see FIG. 8). The elongate arms 712 may reside in a common plane (see FIGS. 7A and 7B).

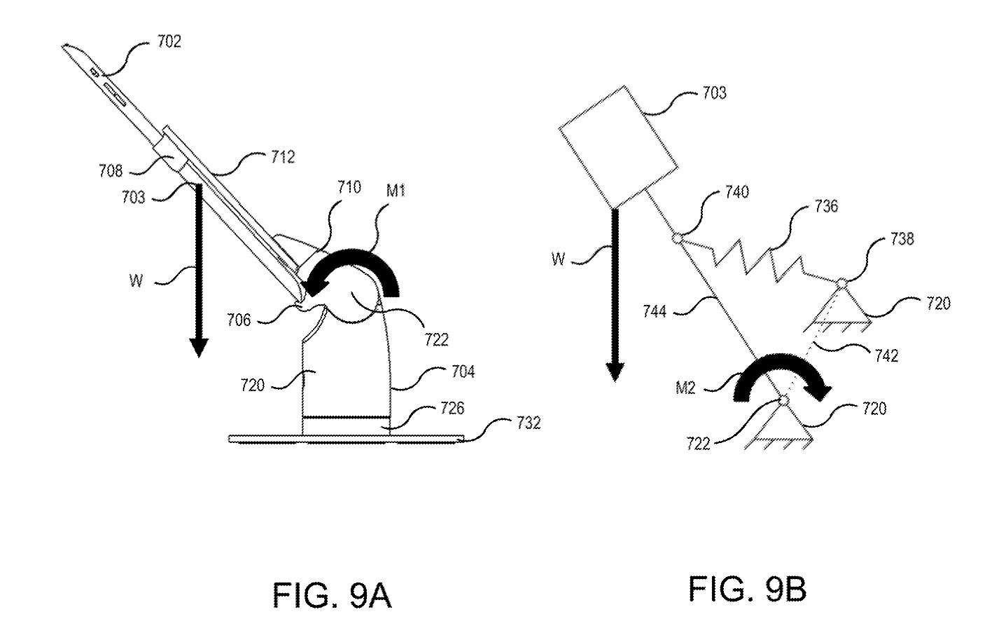

As shown in FIG. 8, the elongate arms 712 may be biased toward one another. A spring may be concentrically arranged about the pivot axis 714 of at least one of the arms 712 and may apply a moment 716 to the arms 712 about the pivot axis 714. The moment 716 may create a clamping force 718 at the free ends of the arms 712, which may cause the horizontal grips 708 to engage opposing sides of the local computing device 702 and compress or pinch the local computing device 702 between the horizontal grips 708. In addition to applying a lateral compressive force to the local computing device 702, the horizontal grips 708 may apply a downward compressive force to the local computing device 702 such that the device 702 is compressed between the horizontal grips 708 and the vertical grip 706. For example, the horizontal grips 708 may pivot in a cam-like motion and/or be made of an elastomeric material such that, upon engagement with opposing sides of the local computing device 702, the grips 708 apply a downward force to the local computing device 702. As shown in FIG. 9, the attached ends of the elongate arms 712 may include matching gear profiles 718 that meshingly engage one another such that pivotal movement of one of the arms 712 about its respective pivot axis 714 causes pivotal movement of the other of the arms 712 about its respective pivot axis 714 in an opposing direction. This gear meshing allows one-handed operation of the opening and closing of the arms 712.

With reference to FIG. 7B, the tiltable member 710 may be rotationally attached to a central body or riser 720 of the stand 704 about a tilt axis 722, which may be oriented perpendicularly to the pivot axis 714 of the elongate arms 712. A rotary actuator module, such as a servomotor, may be placed inside the tiltable member 710 and/or the riser 720 of the stand 704 and may move the member 710 rotationally relative to the riser 720, resulting in a tilting motion 724 of the local computing device 702 about the tilt axis 722. As shown in FIG. 8, a user input button 725 may be coupled to the riser 720. The user input button 725 may be electrically coupled to one or more of the stand components depicted in FIG. 6.

With continued reference to FIG. 7B, the riser 720 may be rotationally attached to a pedestal 726. The riser 720 may be swivelable relative to the pedestal 726 about a pan axis 728, which may be oriented perpendicularly to the tilt axis 722 of the tiltable member 710 and/or the pivot axis 714 of the elongate arms 712. A rotary actuator module, such as a servomotor, may be placed inside the riser 720 and may move the riser 720 rotationally relative to the pedestal 724, resulting in a pan motion 730 of the local computing device 702 about the pan axis 728.

With reference to FIGS. 7A, 7B, and 8, the pedestal 726 may be mounted to a base 732, such as a cylindrical plate, a tripod, or other suitable mounting implement. The pedestal 726 may be removably attached to the base 732 with a base mount fastener 734, which may be inserted through an aperture in the base 732 and threaded into a threaded receptacle 736 formed in the pedestal 726. The base 732 may extend outwardly from the pan axis 728 beyond an outer surface of the riser 720 a sufficient distance to prevent the stand 704 from tipping over when the local computing device 702 is mounted onto the stand 704, regardless of the pan and/or tilt orientation 724, 730 of the computing device 702. In some implementations, the pedestal 726 may be formed as a unitary piece with the base 732 and together referred to as a base. The components depicted schematically in FIG. 6 may be attached to the tiltable member 710, the riser 720, the pedestal 726, the base 732, or any combination thereof. In some implementations, the memory 605, the processor unit(s) 610, the rotary actuator module 615, the power module 635, the sound module 655, or any combination thereof may be housed at least partially within the riser 720.

With reference to FIGS. 9A and 9B, when mounted onto the stand 704, the center of mass 703 of the local computing device 702 may be laterally offset from the tilt axis 722 of the tiltable member 710. The weight W of the local computing device 702 may create a moment M1 about the tilt axis 722, which may affect the operation of a rotary actuator, such as a tilt motor, associated with the tilt axis 722. To counteract the moment M1, a counterbalance spring 736 may be used to neutralize the moment M1. The spring 736 may make the tiltable member 710 and the local computing device 702 neutrally buoyant. A first end 738 of the spring 736 may be attached to the riser 720, and a second end 740 of the spring 736 may be attached to the tiltable member 710. The first end 738 of the spring 736 may be rotationally mounted inside the riser 720 and may be offset from the tilt axis 722 of the member 710 by a distance 742. The second end 740 of the spring 736 may be rotationally mounted inside the tiltable member 710 and may be offset from the tilt axis 722 of the member 710 by a distance 744. The spring force of the spring 736 may create a moment M2 about the tilt axis 722 of the member 710. The moment M2 may inversely match the moment M1, thereby neutralizing the weight W of the local computing device 702 and facilitating operation of the rotary actuator associated with the tilt axis 722.

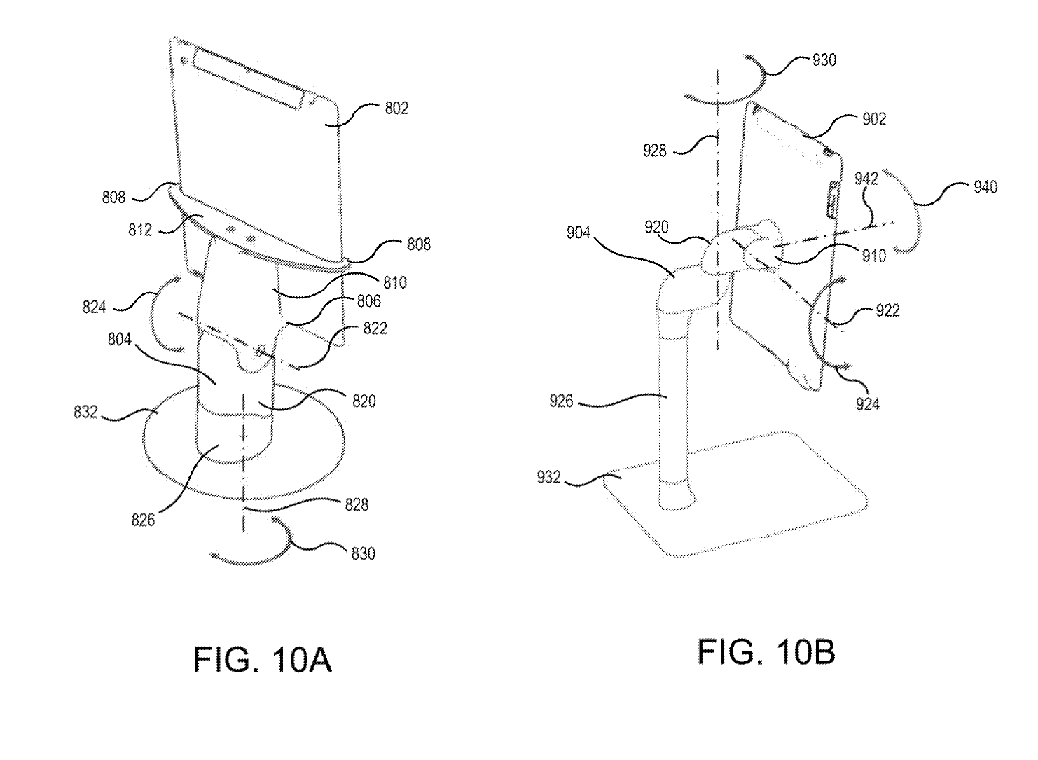

Referring to FIGS. 10A and 10B, additional robotic stands that may be used with the local computing device 120 are depicted. The reference numerals used in FIG. 10A correspond to the reference numerals used in FIGS. 7A-9B to reflect similar parts and components, except the first digit of each reference numeral is incremented by one. The reference numerals used in FIG. 10B correspond to the reference numerals used in FIGS. 7A-9B to reflect similar parts and components, except the first digit of each reference numeral is incremented by two.

Referring to FIG. 10A, a local computing device 802 is mounted onto a robotic stand 804, which has the same features and operation as the robotic stand 704 depicted in FIGS. 7A-9B, except the horizontal grips 808 are attached to a horizontal bar 812 that is attached to a tiltable member 810. The horizontal grips and bar 808, 812 may be formed as one component or piece, which may be attached to an upper surface of the member 810 with multiple fasteners, for example. The preceding discussion of the features and operation of the robotic stand 704 should be considered equally applicable to the alternative robotic stand 804.

Referring to FIG. 10B, a local computing device 902 is mounted onto a robotic stand 904, which has the same features and operation as the robotic stand 704 depicted in FIGS. 7A-9B, except the tiltable member 910 is modified to attach directly to a rear surface of the local computing device 902 such that the robotic stand 904 does not include the vertical grip 706, the horizontal grips 708, or the elongate arms 712. The tiltable member 910 may be swivelable 940 about a roll axis 942 to provide remote control of the local computing device about the roll axis 942, in addition to the pan and tilt axes 928, 922. The preceding discussion of the features and operation of the robotic stand 704 should be considered equally applicable to the alternative robotic stand 804.

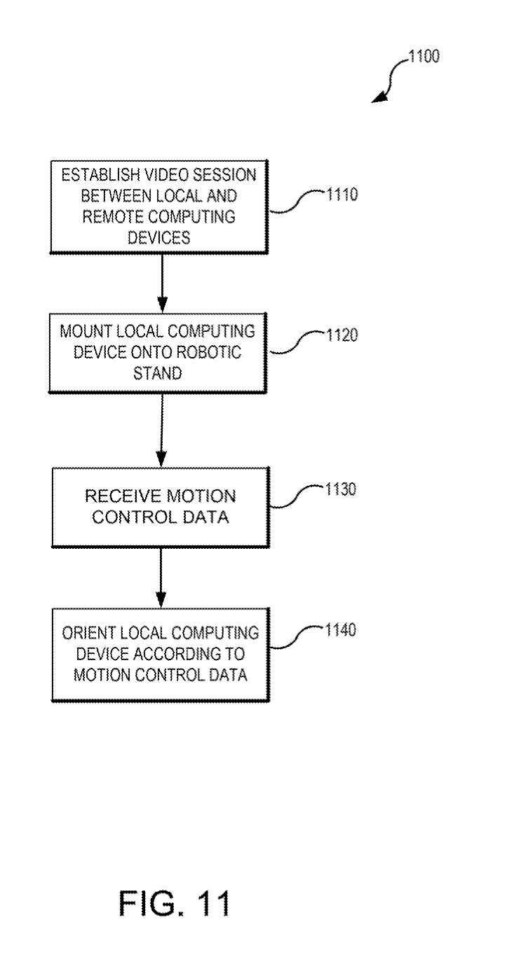

FIG. 11 is a flowchart illustrating a set of operations 1100 for orienting a local computing device supported on a robotic stand in accordance with an embodiment of the disclosure. At operation 1110, a video session is established between a local computing device 120 and a remote computing device 105. The video session may be established by a user of the remote computing device 105 or a user of the local computing device 120 initiating a video client module 220, 270 associated with the respective computing device 105, 120. The video session may establish a video feed between the computing devices 105, 120.

At operation 1120, the local computing device 120 is mounted onto a robotic stand 125, which operation may occur prior to, concurrently with, or subsequent to establishing the video session. To mount the local computing device 120 onto the robotic stand 125, a lower edge of the local computing device 120 may be positioned on a gripping member 706 coupled to the stand 125. Additional gripping members 708 may be positioned in abutment with opposing side edges of the local computing device 120, thereby securing the local computing device 120 to the stand 125. The additional gripping members 708 may be coupled to pivotable arms 712, which may be biased toward one another. In some implementations, a user of the local computing device 120 may pivot the arms 712 away from one another by applying an outwardly-directed force to one of the arms 712. Once the free ends of the arms 712 are spread apart from one another a sufficient distance to permit the local computing device 120 to be placed between the gripping members 708, the local computing device 120 may be positioned between the gripping members 708 and the user may release the arm 712 to permit the arms 712 to drive the gripping members 708 into engagement with opposing sides of the local computing device 120.

At operation 1130, the local computing device 120, the robotic stand 125, or both may receive motion control data. In some situations, the motion control data is received from the remote computing device 105. The motion control data may be transceived between the remote and local computing devices 105, 120 by way of the respective control modules 225, 275. In some situations, the motion control data is received from a sound module 655. The sound module 655 may receive sound waves with a microphone array 665 and transmit an electrical signal containing the sound data to a sound processor 670, which may determine a location of a source of the sound waves. The sound processor 670 may transmit the sound data to a processing unit 610, which may process the sound data into motion control data. Although referred to as separate components, the sound processor 670 and the processing unit 610 may be a single processing unit. The motion control data may include motion commands such as positioning instructions. The positioning instructions may include instructions to pan the local computing device 120 about a pan axis in a specified direction, to tilt the local computing device about a tilt axis in a specified direction, or both.

At operation 1140, the robotic stand 125 may orient the local computing device 120 according to the motion control data. The processing unit 610 may actuate a rotary actuator 620 associated with at least one of a pan axis 728 or a tilt axis 722 by transmitting a signal containing a trigger characteristic (such as a certain current or voltage) to the rotary actuator 620. The processing unit 610 may continue to transmit the signal to the rotary actuator 620 until the robotic stand 125 moves the local computing device 120 into the instructed position. A separate rotary actuator 620 may be associated with each axis 728, 722. The processing unit 610 may monitor the current rotational position of the rotary actuator relative to the instructed rotational position to ensure the robotic stand 125 moves the local computing device 120 into the desired position.

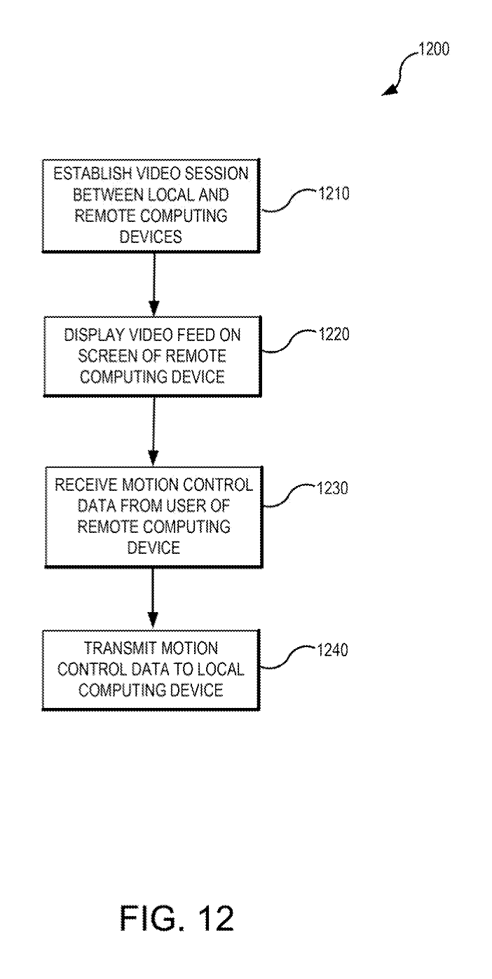

FIG. 12 is a flowchart illustrating a set of operations 1200 for remotely controlling an orientation of a local computing device 120 supported on a robotic stand 125 in accordance with an embodiment of the disclosure. At operation 1210, a video session is established between a remote computing device 105 and a local computing device 120. The video session may be established by a user of the remote computing device 105 or a user of the local computing device 120 initiating a video client module 220, 270 associated with the respective computing device 105, 120. The video session may establish a video feed between the computing devices 105, 120.

At operation 1220, a video feed is displayed on a screen 401 of the remote computing device 105. At operation 1230, motion control data is received from a user of the remote computing device 105. The user of the remote computing device 105 may input a positioning instruction by way of the motion control input module 230. For example, an interactive user interface may be displayed on a screen 401 of the remote computing device 105 and may allow a user to input positioning instructions. The interactive user interface may overlay the video feed data on the screen 401. By interacting with the user interface, the user may generate positioning instructions for transmission to the local computing device 120, the robotic stand 125, or both.

At operation 1240, the remote computing device 105 may transmit motion control data including positioning instructions to the local computing device 120, the robotic stand 125, or both. The motion control data may be transmitted from the remote computing device 105 to the local computing device 120 via the respective control module 225, 275 real-time during a video session between the computing devices 105, 120. The motion control data may include motion commands such as positioning instructions. The positioning instructions may include instructions to pan the local computing device 120 about a pan axis in a specified direction, to tilt the local computing device about a tilt axis in a specified direction, or both.

As discussed, a robotic stand 125 may include pan and tilt functionality. A portion of the stand 125 may be rotatable about a pan axis, and a portion of the stand 125 may be rotatable about a tilt axis. In some implementations, a user of a remote computing device 105 may remotely orient a local computing device 120, which may be mounted onto the robotic stand 125, by issuing motion commands via a communication network, such as the Internet, to the local computing device 120. The motion commands may cause the stand 125 to move about one or more axes, thereby allowing the remote user to remotely control the orientation of the local computing device 120. In some implementations, the motion commands may be initiated autonomously from within the local computing device 120.

The foregoing description has broad application. While the provided examples are discussed in relation to a videoconference between computing devices, it should be appreciated that the robotic stand may be used as a pan and tilt platform for other devices such as cameras, mobile phones, and digital picture frames. Further, the robotic stand may operate via remote web control following commands manually input by a remote user or may be controlled locally by autonomous features of the software running on a local computing device. Accordingly, the discussion of any embodiment is meant only to be explanatory and is not intended to suggest that the scope of the disclosure, including the claims, is limited to these examples. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The term “module” as used herein refers to any known or later developed hardware, software, firmware, artificial intelligence, fuzzy logic, or combination of hardware and software that is capable of performing the functionality associated with that element.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. In methodologies directly or indirectly set forth herein, various steps and operations are described in one possible order of operation, but those skilled in the art will recognize that steps and operations may be rearranged, replaced, or eliminated or have other steps inserted without necessarily departing from the spirit and scope of the present disclosure. Moreover, the following claims are hereby incorporated into this Detailed Description by this reference, with each claim standing on its own as a separate embodiment of the present disclosure.

1. A method of orienting a local computing device during a videoconference established between the local computing device and one or more remote computing devices, the method comprising:
placing a stationary stand on a tabletop;
supporting the local computing device at an elevated position with the stationary stand;
receiving a motion command signal from the local computing device, wherein the motion command signal was generated from a positioning instruction received at the one or more remote computing devices; and
in response to receiving the motion command signal, autonomously moving the local computing device about at least one of a pan axis or a tilt axis according to the positioning instruction.

2. The method of claim 1, wherein the motion command signal comprises a pan motion command operative to pan the local computing device about the pan axis.

3. The method of claim 1, wherein the motion command signal comprises a tilt motion command operative to tilt the local computing device about the tilt axis.

4. The method of claim 1, wherein the moving the local computing device about at least one of a pan axis or a tilt axis comprises moving the local computing device about a pan axis and a tilt axis.

5. The method of claim 4, wherein the moving the local computing device comprises rotating the local computing device about the pan axis and tilting the local computing device about the tilt axis.

6. The method of claim 1, further comprising gripping opposing edges of the local computing device with pivotable arms.

7. The method of claim 6, further comprising biasing the pivotable arms toward one another.

8. The method of claim 1, further comprising counterbalancing a weight of the local computing device about the tilt axis.

9. A method of automatically tracking an object during a videoconference with a computing device supported on a robotic stand, the method comprising:
receiving a positioning instruction indicating a user has selected an object observable in a video feed for centering for automatically tracking;
receiving sound waves associated with the object observable in the video feed with a directional microphone array;
transmitting an electrical signal containing directional sound data to a processor;
determining, by the processor, a location of the object observable in the video feed from the directional sound data;
rotating the robotic stand about at least one of a pan axis or a tilt axis without user interaction to aim the computing device at the location of the object observable in the video feed.

10. The method of claim 9, wherein rotating the robotic stand about at least one of a pan axis or a tilt axis comprises actuating a rotary actuator associated with the at least one of a pan axis or a tilt axis.

11. The method of claim 10, further comprising generating, by the processor, a motion command signal and transmitting the motion command signal to the rotary actuator to actuate the rotary actuator.

12. A method of remotely controlling an orientation of a computing device supported on a robotic stand during a videoconference, the method comprising:
receiving a video feed from the computing device;
displaying the video feed on a screen;
receiving a positioning instruction from a user to move the computing device about at least one of a pan axis or a tilt axis;
sending over a communications network a signal comprising the positioning instruction to the computing device;
receiving a storing instruction from a user to store a pan and tilt position;
in response to receiving the storing instruction, storing the pan and tilt position; and
in response to receiving the storing instruction, associating the pan and tilt position with a user interface element.

13. The method of claim 12, further comprising displaying a user interface that allows a user to remotely control the orientation of the computing device.

14. The method of claim 13, wherein the displaying a user interface comprises overlaying the video feed with a grid comprising a plurality of selectable cells.

15. The method of claim 14, wherein each cell of the plurality of selectable cells is associated with a pan and tilt position of the computing device.

16. The method of claim 12, wherein the receiving the positioning instruction from the user comprises receiving an indication the user pressed an incremental move button.

17. The method of claim 12, wherein the receiving the positioning instruction from the user comprises receiving an indication the user selected an area of the video feed for centering.

18. The method of claim 12, wherein the receiving the positioning instruction from the user comprises receiving an indication the user selected an object of the video feed for automatic tracking.

19. The method of claim 18, wherein the receiving the indication comprises:
receiving a user input identifying the object of the video feed displayed on the screen;
in response to receiving the identification, displaying a graphical symbol on the screen illustrating a time period associated with initiation of the automatic tracking;
continuing to receive the user input identifying the object for the time period; and
in response to completion of the time period, triggering the automatic tracking of the identified object.

20. (canceled)

21. The method of claim 12, further comprising storing a still image of the video feed and associating position data with the still image in response to a gesture performed by the user.

22. A robotic stand operative to orient a computing device about at least one of a pan axis or a tilt axis during a videoconference, the robotic stand comprising:
a base;
a first member attached to the base and swivelable relative to the base about the pan axis;
a second member attached to the first member and tiltable relative to the first member about the tilt axis, the second member comprising multiple elongate arms pivotally attached thereto and biased toward one another, wherein the computing device is attached to the second member; and
a remotely-controllable rotary actuator associated with the first member and operative to swivel the first member about the pan axis.

23. The robotic stand of claim 22, further comprising a remotely-controllable rotary actuator associated with the second member and operative to tilt the second member about the tilt axis.

24. (canceled)

25. (canceled)

26. The robotic stand of claim 24, further comprising a gripping member attached to a free end of each elongate arm of the multiple elongate arms.

27. The robotic stand of claim 26, further comprising a gripping member attached directly to the second member.

28. The robotic stand of claim 22, further comprising a counterbalance spring attached at a first end to the first member and at a second end to the second member, wherein the counterbalance spring is offset from the tilt axis.

29. The robotic stand of claim 22, further comprising a microphone array attached to at least one of the base, the first member, or the second member.
